(19) United States
(12) Patent Application Publication
(10) Pub. No.: US 2025/0212201 A1
(43) Pub. Date: Jun. 26, 2025

(54) Mapping Low Latency, Low Loss, and Scalable Throughput (L4S) Data Flows

(71) Applicant: Cisco Technology, Inc., San Jose, CA (US)

(72) Inventors: Binita Gupta, San Diego, CA (US); Jerome Henry, Pittsboro, NC (US); Juan Carlos Zuniga, Montreal (CA)

(21) Appl. No.: 18/597,882

(22) Filed: Mar. 6, 2024

Related U.S. Application Data
(60) Provisional application No. 63/614,905, filed on Dec. 26, 2023.

(51) Int. Cl. H04W 72/1263; H04W 28/02; H04W 28/08; H04W 52/02

(52) U.S. Cl. CPC H04W 72/1263; H04W 28/0263; H04W 28/0925; H04W 52/0229

(57) ABSTRACT

Devices, networks, systems, methods, and processes for mapping Low Latency, Low Loss, and Scalable throughput (L4S) traffic are described herein. A device may determine a mapping policy and configure the mapping policy on a wireless device. The mapping policy can facilitate mapping L4S data flows with User Priority (UP) values and/or Traffic Identifier (TID) values. The wireless device can generate and share a restricted Target Wake Time (rTWT) schedule with the device. The rTWT schedule may be indicative of a service interval and a service period. The wireless device may also transmit one or more rTWT TID values for L4S communication during the service period. The wireless device and the device may map the L4S data flows with the one or more rTWT TID values and can transmit and/or receive the L4S data flows during the service period. The device may prioritize the L4S data flows over non-L4S data flows.

### CROSS-REFERENCE TO RELATED APPLICATION

This application claims the benefit of U.S. Provisional Patent Application No. 63/614,905, filed Dec. 26, 2023, which is incorporated by reference herein in its entirety.

The present disclosure relates to digital communication. More particularly, the present disclosure relates to Low Latency, Low Loss, and Scalable throughput (L4S) systems.

### BACKGROUND

Digital communication networks involve communication between multiple interconnected devices. In real-time or near-real-time applications such as streaming video and playing multi-player games on the devices, latency of the communication is required to be minimal. For such applications, Low Latency, Low Loss, and Scalable throughput (L4S) provides low queuing latency, minimal congestion loss, and scalable throughput control. L4S aims to minimize time spent by data packets in queues, thereby reducing overall latency experienced by the applications. L4S also allows for efficiently managing congestion without causing loss of the data packets. Further, L4S provides scalable throughput, thereby allowing the digital networks to adapt to varying levels of demand from the devices.

In conventional systems, multiple challenges arise in wireless shared media access scenarios, which are often stochastic and difficult to predict. These challenges arise especially in densely populated wireless environments where multiple wireless devices access a medium simultaneously. L4S traffic is affected by contention when multiple wireless devices access the medium simultaneously. In many conventional systems, Target Wake Time (TWT) facilitates wireless devices to coordinate with an Access Point (AP) to establish a predetermined schedule for data transmission and reception. TWT allows optimizing power consumption in the wireless devices, by enabling the wireless devices to efficiently manage their sleep and active periods.

However, the conventional systems utilizing TWT primarily focus on power savings and not on latency reduction. These conventional systems do not cater to low latency demands of the real-time or near-real-time applications. The conventional systems utilizing TWT also lack mechanisms for handling the L4S traffic or specifying latency requirements of the L4S traffic to the AP. Therefore, there is a need for a technique to efficiently manage the L4S traffic and to provide the power savings by utilizing TWT.

### SUMMARY OF THE DISCLOSURE

Systems and methods for mapping Low Latency, Low Loss, and Scalable throughput (L4S) data flows in accordance with embodiments of the disclosure are described herein. In some embodiments, a device includes a processor, and a memory communicatively coupled to the processor, wherein the memory includes a traffic mapping logic.

In some embodiments, a traffic mapping logic is configured to determine a mapping policy for one or more Low Latency, Low Loss, Scalable throughput (L4S) data flows, configure the mapping policy on a wireless device, receive a restricted Target Wake Time (rTWT) schedule from the wireless device, receive a downlink L4S data flow associated with the wireless device, and schedule the downlink L4S data flow based on the rTWT schedule.

In some embodiments, the mapping policy is indicative of one or more User Priority (UP) values or one or more Traffic Identifier (TID) values associated with the one or more L4S data flows.

In some embodiments, the rTWT schedule is indicative of at least one service period occurring at one or more service intervals in which the wireless device transmits or receives the one or more L4S data flows.

In some embodiments, the rTWT schedule is further indicative of one or more rTWT TID values of the one or more TID values associated with the one or more L4S data flows.

In some embodiments, the rTWT schedule further includes a Quality of Service (QoS) Information Element (IE) indicative of one or more Quality of Service (QoS) parameters associated with the one or more L4S data flows.

In some embodiments, the traffic mapping logic is further configured to receive, from the wireless device, a Stream Classification Service (SCS) request indicative of the one or more QoS parameters associated with the one or more L4S data flows.

In some embodiments, scheduling the downlink L4S data flow includes determining an rTWT TID value associated with the downlink L4S data flow based on the rTWT schedule, and mapping the downlink L4S data flow to the rTWT TID value.

In some embodiments, scheduling the downlink L4S data flow further includes determining the one or more QoS parameters associated with the downlink L4S data flow based on the SCS request or the QoS IE in the rTWT schedule, and transmitting the downlink L4S data flow mapped to the rTWT TID value to the wireless device during the at least one service period based on the one or more QoS parameters.

In some embodiments, the traffic mapping logic is further configured to receive a non-L4S data flow mapped to the rTWT TID value, and assign a higher priority for scheduling the downlink L4S data flow and a lower priority for scheduling the non-L4S data flow based on the mapping policy.

In some embodiments, the wireless device maps an uplink L4S data flow to an rTWT TID value associated with the uplink L4S data flow based on the rTWT schedule.

In some embodiments, the mapping policy is an enhanced Differentiated Services Code Point (DSCP) policy.

In some embodiments, the traffic mapping logic is further configured to transmit, to the wireless device, an enhanced DSCP policy request indicative of the mapping policy for the L4S data flow, and receive, from the wireless device, an enhanced DSCP policy response indicative of acceptance of the mapping policy for the L4S data flow.

In some embodiments, a traffic mapping logic is configured to receive a mapping policy for one or more Low Latency, Low Loss, Scalable throughput (L4S) data flows, determine a service interval and a service period for transmission or reception of the one or more L4S data flows, generate a restricted Target Wake Time (rTWT) schedule indicative of the service interval and the service period based on the mapping policy, and transmit an uplink L4S data flow during the service period based on the rTWT schedule.

In some embodiments, the mapping policy is indicative of one or more User Priority (UP) values or one or more Traffic Identifier (TID) values associated with the one or more L4S data flows.

In some embodiments, the rTWT schedule is further indicative of one or more rTWT TID values of the one or more TID values associated with the one or more L4S data flows.

In some embodiments, transmitting the uplink L4S data flow includes determining an rTWT TID value associated with the uplink L4S data flow based on the rTWT schedule, and mapping the uplink L4S data flow to the rTWT TID value.

In some embodiments, transmitting the uplink L4S data flow includes mapping the uplink L4S data flow to a predetermined rTWT TID value.

In some embodiments, a method includes determining a mapping policy for one or more Low Latency, Low Loss, Scalable throughput (L4S) data flows, configuring the mapping policy on a wireless device, receiving a restricted Target Wake Time (rTWT) schedule from the wireless device, receiving a downlink L4S data flow associated with the wireless device, and scheduling the downlink L4S data flow based on the rTWT schedule.

In some embodiments, a method includes determining an rTWT Traffic Identifier (rTWT TID) value associated with the downlink L4S data flow based on the rTWT schedule, mapping the downlink L4S data flow to the rTWT TID value, determining a service period based on the rTWT schedule, and transmitting the downlink L4S data flow to the wireless device during the service period.

In some embodiments, a method includes receiving a non-L4S data flow corresponding to the rTWT TID value, and assigning a higher UP value to the downlink L4S data flow and a lower UP value to the non-L4S data flow based on the mapping policy.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of Low Latency, Low Loss, and Scalable throughput (L4S) communication in a wireless communication network, in accordance with various embodiments of the disclosure;

FIG. 3 is a conceptual illustration of a restricted Target Wake Time (rTWT) operation in a wireless communication network, in accordance with various embodiments of the disclosure;

FIG. 4 is a conceptual network diagram of various environments that a traffic mapper may operate on a plurality of network devices, in accordance with various embodiments of the disclosure;

FIG. 5 is a flowchart depicting a process for transmitting L4S data flows by an Access Point (AP), in accordance with various embodiments of the disclosure;

FIG. 6 is a flowchart depicting a process for transmitting L4S data flows by a wireless device, in accordance with various embodiments of the disclosure;

FIG. 7 is a flowchart depicting a process for prioritizing L4S data flows, in accordance with various embodiments of the disclosure; and

FIG. 8 is a conceptual block diagram of a device suitable for configuration with a traffic mapping logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that map and schedule Low Latency, Low Loss, and Scalable throughput (L4S) data flows. A communication network may comprise an Access Point (AP) and one or more wireless devices. The AP and the one or more wireless devices may be Low Latency, Low Loss, Scalable throughput (L4S) enabled devices. A wireless device can implement one or more real-time or near-real time applications such as but not limited to streaming or multi-player games, for example. Such applications may generate L4S traffic that requires L4S communication with the AP for ensuring low latency. In many embodiments, the wireless device can determine a periodicity, i.e., a service interval, and a service period for the L4S communication. The L4S communication may include uplink L4S communication, downlink L4S communication, or Peer to Peer (P2P) L4S communication, for example. The periodicity, i.e., the service interval can indicate a time interval between transmission or reception of L4S data flows from or to the wireless device. In some embodiments, for example, the service interval may indicate how often the wireless device transmits or receives the L4S data flows. The service period can indicate a time period when the wireless device transmits or receives the L4S data flows. In certain embodiments, the wireless device may determine whether one or more uplink or downlink data flows are L4S. In that, in some more embodiments, the wireless device can determine if a data packet in an uplink or downlink data flow includes a congestion indicator or an L4S indicator. In numerous embodiments, the congestion indicator may be an Explicit Congestion Notification (ECN) indicator, for example. Examples of ECN indicators include but are not limited to ECN Capable Transport (ECT) such as ECT(1) or ECT(0) or Congestion Experienced (CE). Upon detecting the congestion indicator, the wireless device may determine that the uplink or downlink data flow is L4S. Similarly, the AP can detect the congestion indicator in the uplink or downlink data flow and can determine whether the uplink or downlink data flow is L4S.

In a number of embodiments, the AP may determine a mapping policy for the L4S data flows. In some embodiments, for example, the mapping policy can indicate one or more User Priority (UP) values or Traffic Identifier (TID) values to which the L4S data flows may be mapped. The UP values or TID values can be mapped to uplink L4S data flows, downlink L4S data flows, or P2P L4S data flows. In certain embodiments, the mapping policy can be an enhanced Differentiated Services Code Point (DSCP) policy. In that, the enhanced DSCP policy may indicate mapping between one or more DSCP values and one or more corresponding UP values. The enhanced DSCP policy can be a feature in Wi-Fi Alliance (WFA) Quality of Service (QoS) management. Accordingly, the AP may map the L4S data flows to the one or more UP values or TID values based on the mapping policy. The AP can configure the mapping policy on the wireless device. In more embodiments, the AP may utilize a predetermined protocol or a proprietary protocol to configure the mapping policy on the wireless device.

In more embodiments, the wireless device may utilize the predetermined protocol or the proprietary protocol to map the L4S data flows. In some more embodiments, the predetermined protocol or the proprietary protocol can facilitate mapping of the L4S data flows without requiring changes to standard DSCP policy, thereby providing flexibility and customization in configuring the mapping policy on the wireless device. Accordingly, the wireless device can map the one or more L4S data flows with the one or more UP values or TID values. In numerous embodiments, headers of one or more data packets in the data flows may comprise a UP value, a DSCP value, and/or a TID value. In still more embodiments, the AP can modify, change, or optimize the mapping policy based on one or more Artificial Intelligence (AI) or Machine Learning (ML) techniques. In many further embodiments, the AP may dynamically modify, change, or optimize the mapping policy based on one or more changes in network conditions. In many more embodiments, the AP can transmit an enhanced DSCP policy request to the wireless device. The enhanced DSCP policy request can be indicative of the mapping policy for the L4S data flow. The AP may further receive an enhanced DSCP policy response from the wireless device. The enhanced DSCP policy response can be indicative of acceptance of the mapping policy for the L4S data flow by the wireless device.

In various embodiments, the wireless device can select a predetermined UP value or a predetermined TID value for mapping the L4S data flows. In some embodiments, the wireless device may select a high UP value for the L4S data flows, for example. For example, in certain embodiments, the wireless device may dynamically select the high UP value based on one or more latency requirements or one or more QoS characteristics of the uplink L4S data flows. In more embodiments, the wireless device may select one or more specific UP values or one or more specific TID values based on the mapping policy configured on the wireless device. For example, in some more embodiments, the wireless device can select a specific UP value or a specific TID value preconfigured on the wireless device.

In additional embodiments, the wireless device may generate a restricted Target Wake Time (rTWT) schedule. The rTWT schedule can be indicative of the service interval and the service period for the L4S communication. In the rTWT schedule, at least one service period occurs at one or more service intervals. The wireless device can further select the one or more TID values as rTWT TID values based on the mapping policy. The rTWT TID values may be utilized by the wireless device and the AP for L4S communication during the service period. In some embodiments, during rTWT setup, the wireless device may transmit a QoS Information Element (IE) to the AP. The QoS IE can be indicative of the one or more QoS parameters of the L4S data flows. In some more embodiments, the QoS IE may be transmitted in a Stream Classification Service (SCS) request signal and/or an SCS response signal. In that, the wireless device can transmit an SCS request to the AP indicative of the QoS characteristics of the L4S data flows. In some more embodiments, the SCS request may further include a Traffic Classification (TCLAS) element associated with the L4S data flows. The AP may utilize the TCLAS element to identify whether the data flow is L4S. In that, in some embodiments, the wireless device can indicate a specific TCLAS element for specific L4S data flows based on Internet Protocol (IP) addresses and/or Fully Qualified Domain Name (FQDN), for example. Alternatively, in some more embodiments, the wireless device can indicate a single TCLAS element for all L4S traffic determined based on the congestion indicator. The wireless device may also indicate a combination of the specific TCLAS element associated with the specific L4S data flow and the single TCLAS element for other L4S data flows. In numerous embodiments, the wireless device may utilize an enhanced TCLAS element for L4S traffic classification.

In further embodiments, in uplink, the wireless device may wake up and communicate with the AP during the service period. Since the wireless device can schedule wake up and sleep time based on the rTWT schedule, the wireless device may reduce power utilization, thereby leading to power savings. After the wireless device wakes up, the wireless device can map an uplink L4S data flow with an rTWT TID value and transmit the uplink L4S data flow mapped with the rTWT TID value during the service period. The rTWT TID value can be utilized to identify a specific L4S data flow in the service period. In some embodiments, different L4S data flows having different QoS characteristics may be mapped to different rTWT TID values. The rTWT TID values can also be utilized to carry over or continue the transmission or reception of the L4S data flows into the service period. In certain embodiments, other wireless devices that are not members of an rTWT group may ensure that their Transmission Opportunity (TXOP) ends before start of the service period, thereby reducing contention for the L4S communication between the AP and the wireless device during the service period. The AP may receive the uplink L4S data flow and can transmit the uplink L4S data flow based on the one or more QoS characteristics indicated in the QoS IE element received during the rTWT setup or the one or more QoS characteristics indicated in the SCS request.

In many more embodiments, in downlink, the AP can receive a downlink L4S data flow and map the downlink L4S data flow to the rTWT TID value. Thereafter, the AP may transmit the downlink L4S data flow mapped to the rTWT TID value to the wireless device during the service period. In some embodiments, the AP can receive a non-L4S data flow assigned to same rTWT TID value as the L4S data flow. In that, the AP may prioritize the L4S data flow over the non-L4S data flow. In certain embodiments, the AP can prioritize the L4S data flow by assigning a higher priority for scheduling the L4S data flow and a lower priority for scheduling the non-L4S data flow. In more embodiments, the AP may enqueue the L4S data flow in an L4S queue and the non-L4S data flow in a classic queue. In that, the AP can implement a dual-queue Active Queue Management (AQM) system for scheduling the L4S data flows and the non-L4S data flows.

Advantageously, the traffic mapping technique of the present disclosure can facilitate scheduling the L4S traffic during rTWT service periods of the wireless devices, thereby reducing power consumption of the wireless devices and also reducing contention in accessing wireless medium. The traffic mapping technique also facilitates specifying the one or more QoS characteristics of the L4S traffic. The traffic mapping technique provides enhanced L4S classification and scheduling. The communication system of the present disclosure can ensure optimal prioritization and QoS for the L4S traffic in both: uplink and downlink.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

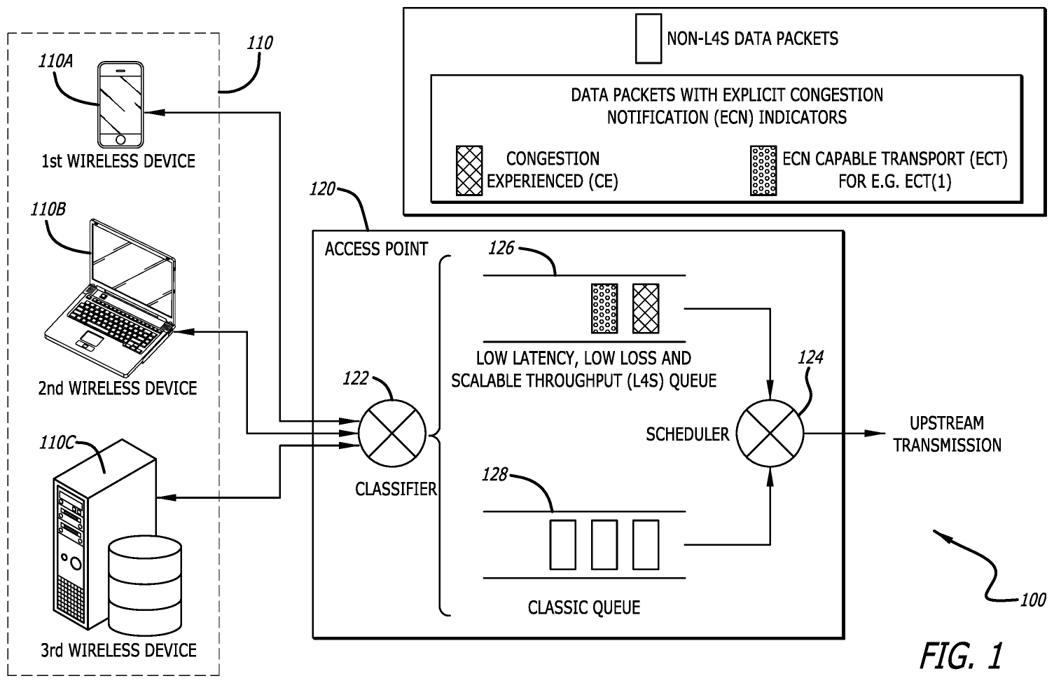

Referring to FIG. 1, a conceptual illustration of a wireless communication network 100, in accordance with various embodiments of the disclosure is shown. In many embodiments, the wireless communication network 100 may include a plurality of wireless devices 110 including the first through third wireless devices 110A, 110B, and 110C. The examples of the wireless devices 110 may include but are not limited to smartphones, computers, laptops, network devices, or any other electronic devices, etc. The wireless devices 110 may be in communication with an Access Point (AP) 120. In that, the wireless devices 110 may be in communication with the AP 120 wirelessly by way of Wi-Fi. The wireless communication network 100 may utilize 6 GHz, 5 GHz or 2.4 GHz bands or Millimeter Waves (mmWave) frequencies, for example. Some of the wireless devices 110 may be L4S enabled wireless devices 110. The AP 120 may also be L4S enabled. In some embodiments, during establishment of links between the wireless devices 110 and the AP 120, i.e., while associating the wireless devices 110 with the AP 120, the wireless devices 110 and the AP 120 can exchange L4S capability support signaling. Upon receiving the L4S capability support signaling by the L4S enabled wireless devices 110, the AP 120 may provide an optimized L4S communication channel to the L4S enabled wireless devices 110. In that, the AP 120 can include a classifier 122 to classify incoming data flows as L4S or non-L4S. The AP 120 may also implement a dual queue, viz., an Active Queue Management (AQM) queue for L4S data flows, i.e., an L4S queue 126 and a classic queue 128 for non-L4S data flows. The AP 120 can further include a scheduler 124 to schedule the incoming data flows based on whether the incoming data flows are L4S or non-L4S. In certain embodiments, the scheduler 124 may be a conditional priority scheduler that can prioritize the L4S data flows over the non-L4S data flows. Accordingly, the AP 120 may receive the incoming data flows and transmit the incoming data flows based on whether the data flows qualify for L4S treatment or whether the data flows are non-L4S data flows.

In a number of embodiments, one of the L4S enabled wireless devices 110 can initiate an upstream data flow. If the upstream data flow is marked as L4S, the AP 120 may enqueue the upstream data flow in the L4S queue 126. If the upstream data flow is not marked as L4S, the AP 120 may receive a plurality of upstream data packets in the upstream data flow. The AP 120 may parse the upstream data packets to determine whether any upstream data packet includes a congestion indicator. In some embodiments, the congestion indicator may be an Explicit Congestion Notification (ECN) indicator. Upon detecting the ECN indicator in one of the upstream data packets, the AP 120 can treat the upstream data flow as an upstream L4S data flow. In some embodiments, the ECN indicator may be an ECN Capable Transport (ECT) value or a Congestion Experienced (CE) value, for example. In certain embodiments, the ECT value of ECT(1) may be classified as L4S, for example.

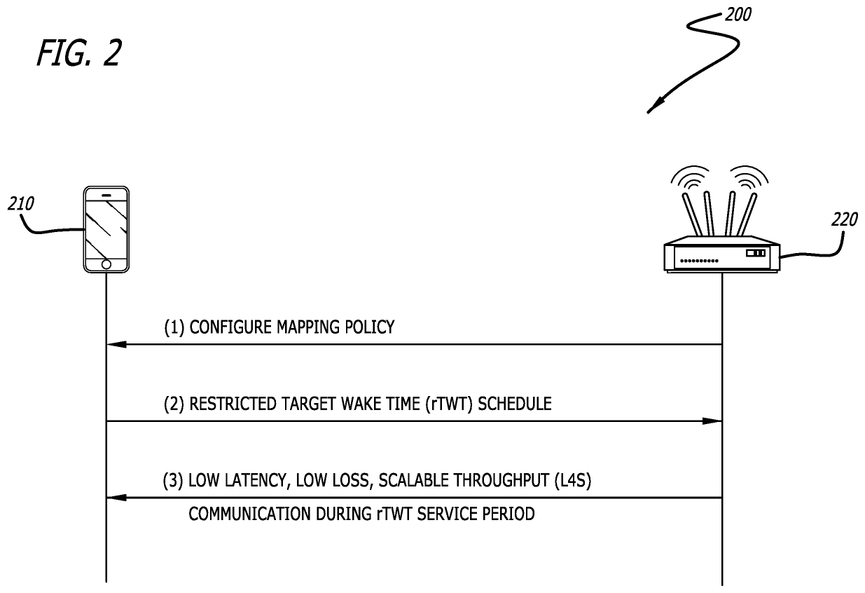

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, the AP 120 may facilitate L4S treatment for the L4S data flows, thereby reducing latency. The elements depicted in FIG. 1 may also be interchangeable with other elements of FIGS. 2-8 as required to realize a particularly desired embodiment.

Referring to FIG. 2, a conceptual illustration of L4S communication in a wireless communication network 200, in accordance with various embodiments of the disclosure is shown. In many embodiments, the wireless communication network 200 may include a wireless device 210 and an AP 220. The AP 220 may determine a mapping policy for the L4S data flows. In some embodiments, for example, the mapping policy can indicate one or more User Priority (UP) values or Traffic Identifier (TID) values to which the L4S data flows may be mapped. The UP values or TID values can be mapped to uplink L4S data flows, downlink L4S data flows, or P2P L4S data flows between the AP 220 and the wireless device 210. In downlink, the AP 220 may map the downlink L4S data flows to the one or more UP values or TID values based on the mapping policy. The AP 220 can configure the mapping policy on the wireless device 210. In uplink, the wireless device 210 may map the uplink L4S data flows with the one or more UP values or TID values based on the mapping policy.

In a number of embodiments, the wireless device 210 may generate a restricted Target Wake Time (rTWT) schedule. The rTWT schedule can be indicative of a service interval and a service period for the L4S communication. The wireless device 210 can further select the one or more TID values as rTWT TID values based on the mapping policy for the L4S communication within the service period. In some embodiments, for example, the rTWT schedule can be further indicative of the rTWT TID values for the L4S communication within the service period. The wireless device 210 may share the rTWT schedule with the AP 220. In certain embodiments, the wireless device 210 can share the rTWT TID values with the AP 220 during rTWT setup.

In various embodiments, during the service period, the AP 220 and the wireless device 210 may map the uplink L4S data flows and the downlink L4S data flows with the rTWT TID values. In some embodiments, the wireless device 210 may wake up and communicate with the AP 220 during the service period. Since the wireless device 210 can schedule wake up and sleep time based on the rTWT schedule, the wireless device 210 may reduce power utilization, thereby leading to power savings. After the wireless device 210 wakes up, the wireless device 210 can map an uplink L4S data flow with an rTWT TID value and transmit the uplink L4S data flow mapped with the rTWT TID value to the AP 220 during the service period. In some embodiments, other wireless devices that are not members of an rTWT group may ensure that their Transmission Opportunity (TXOP) ends before start of the service period, thereby reducing contention for the L4S communication between the AP 220 and the wireless device 210 during the service period. The AP 220 can receive a downlink L4S data flow and map the downlink L4S data flow to the rTWT TID value. Thereafter, the AP 220 may transmit the downlink L4S data flow mapped to the rTWT TID value to the wireless device 210 during the service period.

Although a specific embodiment for the L4S communication in the wireless communication network 200 for carrying out the various steps, processes, methods, and operations described herein is discussed with respect to FIG. 2, any of a variety of systems and/or processes may be utilized in accordance with embodiments of the disclosure. For example, the AP 220 can dynamically modify or change the mapping policy. The elements depicted in FIG. 2 may also be interchangeable with other elements of FIG. 1 and FIGS. 3-8 as required to realize a particularly desired embodiment.

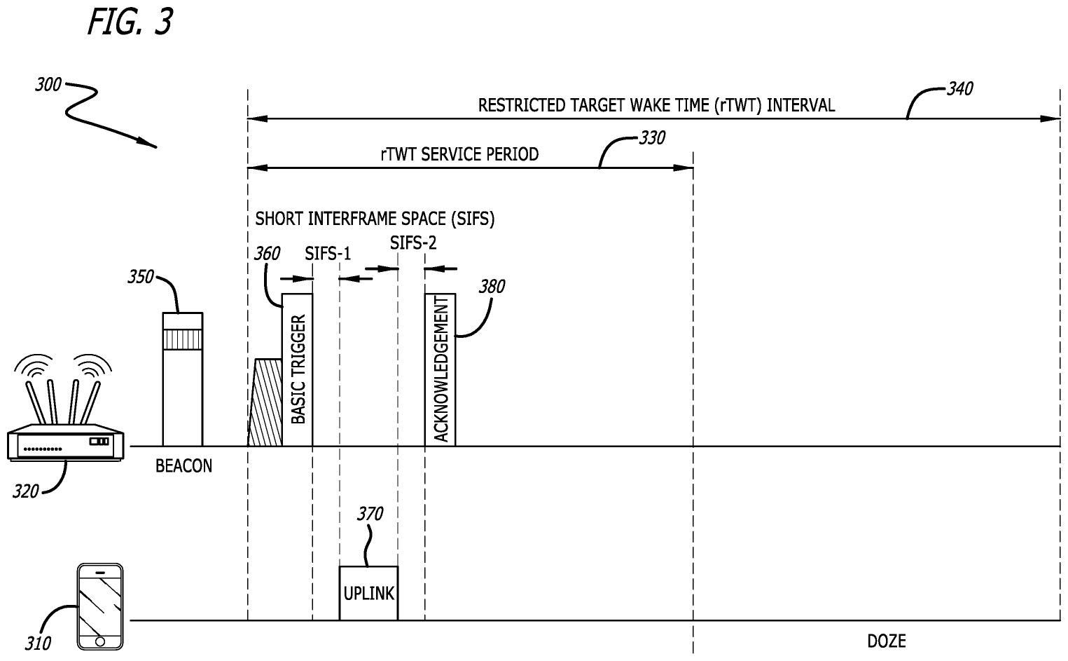

Referring to FIG. 3, a conceptual illustration of an rTWT operation in a wireless communication network 300, in accordance with various embodiments of the disclosure is shown. In many embodiments, the wireless communication network 300 can include a wireless device 310 and an AP 320. The wireless device 310 and the AP 320 may be in communication by way of one or more Wi-Fi frequencies, such as but not limited to 2.4 GHz, 5 GHz, or 6 GHz bands etc. for example. The wireless device 310 can establish a membership in an rTWT schedule by negotiation with the AP 320. The rTWT schedule may include an rTWT service period 330 and an rTWT interval 340. The rTWT negotiation may be performed at the time of association of the wireless device 310 with the AP 320 or anytime thereafter. In some embodiments, the AP 320 can announce the rTWT service period 330 to the wireless device 310 and other wireless devices in the wireless communication network 300. The other wireless devices (not shown) that have not established membership in the rTWT schedule may receive and store information such as but not limited to, duration and/or interval of the rTWT service period 330, for example. Thereafter, the other wireless devices that have not established membership in the rTWT schedule can end the TXOP before the rTWT service period 330 starts. Further, legacy wireless devices in the wireless communication network 300 may also be quieted when the rTWT service period 330 starts. In a number of embodiments, the rTWT service period 330 may be utilized to support time-sensitive operations, such as but not limited to transmission and/or reception of the L4S data flows between the AP 320 and the wireless device 310 etc. for example. The rTWT service period 330 can, hence, facilitate in better increasing predictability of channel access for time-sensitive operations. In the rTWT service period 330, the time-sensitive operations, such as the L4S data flows in this case, may be assigned higher priority for scheduling transmissions.

In various embodiments, the rTWT can be operated in a trigger mode. In the trigger mode, the AP 320 may trigger the wireless device 310 for time-sensitive operations. In some embodiments, for example, the AP 320 can broadcast one or more rTWT parameters in a beacon frame 350. Thereafter, the AP 320 may transmit a trigger frame 360 to the wireless device 310. The wireless device 310 can receive the trigger frame 360 and transmit uplink data by way of an uplink frame 370. The uplink frame 370 may comprise the L4S data flows. The AP 320 may determine the mapping policy for the L4S data flows. The AP 320 can configure the mapping policy on the wireless device 310. The wireless device 310 may select the rTWT TID values for the L4S communication within the rTWT service period 330 based on the mapping policy. During the rTWT service period 330, the AP 320 and/or the wireless device 310 may map the L4S data flows with the rTWT TID values based on the mapping policy.

In additional embodiments, the trigger frame 360 and the uplink frame 370 can be separated by a first Short Interframe Space (SIFS), i.e., SIFS-1. The AP 320 can receive the uplink data, for example, the L4S data flows transmitted by the wireless device 310 in the rTWT service period 330. The AP 320 may transmit an acknowledgement frame 380 to the wireless device 310. The uplink frame 370 and the acknowledgement frame 380 may be separated by an SIFS-2. The acknowledgement frame 380 can be indicative of the AP 320 successfully receiving the uplink frame 370. After an end of the rTWT service period 330, during the rTWT interval 340 or until the start of next rTWT service period, the wireless device 310 can operate in a low power mode, such as but not limited to sleep mode, standby mode etc.

Although a specific embodiment for the rTWT operation in a wireless communication network 300 for carrying out the various steps, processes, methods, and operations described herein is discussed with respect to FIG. 3, any of a variety of systems and/or processes may be utilized in accordance with embodiments of the disclosure. For example, the AP 320 may dynamically schedule transmissions of the L4S data flows. The elements depicted in FIG. 3 may also be interchangeable with other elements of FIGS. 1-2 and FIGS. 4-8 as required to realize a particularly desired embodiment.

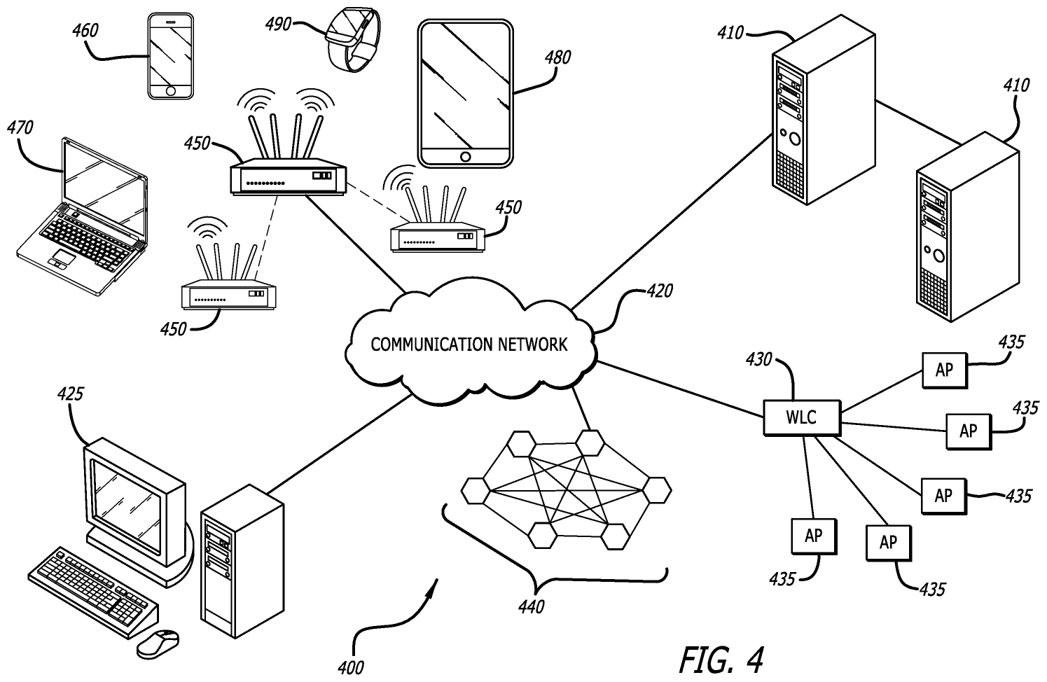

Referring to FIG. 4, a conceptual network diagram 400 of various environments that a traffic mapper may operate on a plurality of network devices, in accordance with various embodiments of the disclosure is shown. Those skilled in the art will recognize that the traffic mapper can be comprised of various hardware and/or software deployments and can be configured in a variety of ways. In many embodiments, the traffic mapper can be configured as a standalone device, exist as a logic in another network device, be distributed among various network devices operating in tandem, or remotely operated as part of a cloud-based network management tool. In further embodiments, one or more servers 410 can be configured with or otherwise operate the traffic mapper. In many embodiments, the traffic mapper may operate on one or more servers 410 connected to a communication network 420. The communication network 420 can include wired networks or wireless networks. In many embodiments, the communication network 420 may be a Wi-Fi network operating on various frequency bands, such as, 2.4 GHz, 5 GHz, or 6 GHz. In further embodiments, the traffic mapper operating on the servers 410 can facilitate mapping the L4S data flows to the one or more UP values or the one or more TID values. The traffic mapper can be provided as a cloud-based service that can service remote networks, such as, but not limited to a deployed network 440. In many embodiments, the traffic mapper can be a logic that maps the L4S data flows to the one or more UP values or the one or more TID values.

However, in additional embodiments, the traffic mapper may be operated as a distributed logic across multiple network devices. In the embodiment depicted in FIG. 4, a plurality of APs 450 can operate as the traffic mapper in a distributed manner or may have one specific device operate as the traffic mapper for all of the neighboring or sibling APs 450. The APs 450 facilitate Wi-Fi connections for various electronic devices, such as but not limited to mobile computing devices including laptop computers 470, cellular phones 460, portable tablet computers 480 and wearable computing devices 490.

In further embodiments, the traffic mapper may be integrated within another network device. In the embodiment depicted in FIG. 4, a wireless LAN controller (WLC) 430 may have an integrated traffic mapper that the WLC 430 can use to map the L4S data flows within the various APs 435 that the WLC 430 is connected to, either wired or wirelessly. In still more embodiments, a personal computer 425 may be utilized to access and/or manage various aspects of the traffic mapper, either remotely or within the network itself. In the embodiment depicted in FIG. 4, the personal computer 425 communicates over the communication network 420 and can access the traffic mapper of the servers 410, or the network APs 450, or the WLC 430.

Although a specific embodiment for various environments that the traffic mapper may operate on a plurality of network devices suitable for carrying out the various steps, processes, methods, and operations described herein is discussed with respect to FIG. 4, any of a variety of systems and/or processes may be utilized in accordance with embodiments of the disclosure. In many non-limiting examples, the traffic mapper may be provided as a device or software separate from the network devices or the traffic mapper may be integrated into the network devices. The elements depicted in FIG. 4 may also be interchangeable with other elements of FIGS. 1-3 and 5-8 as required to realize a particularly desired embodiment.

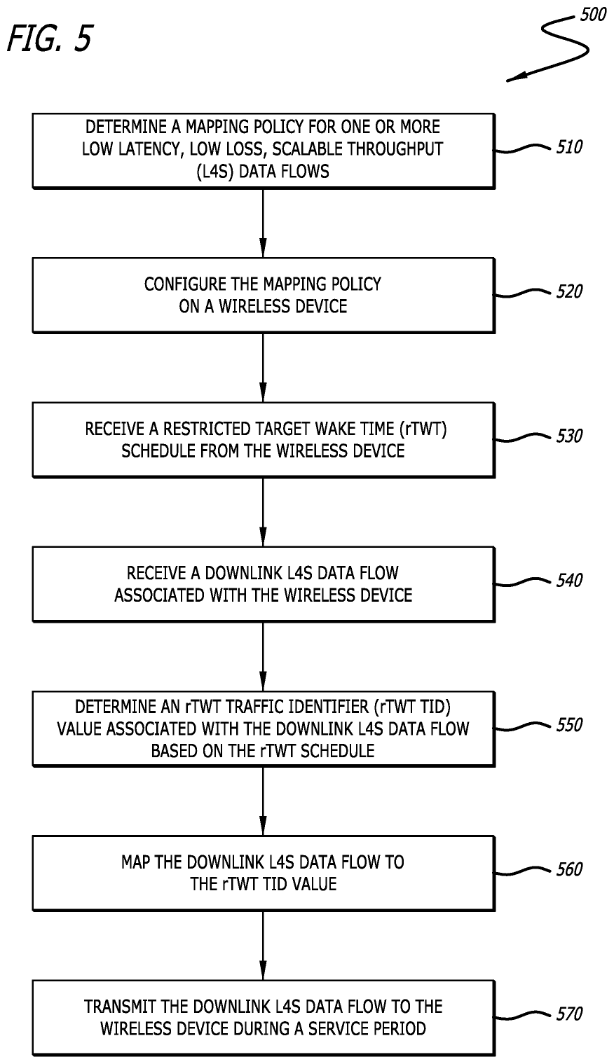

Referring now to FIG. 5, a flowchart depicting a process 500 for transmitting the L4S data flows by the AP, in accordance with various embodiments of the disclosure is shown. In many embodiments, the process 500 may determine the mapping policy for the L4S data flows (block 510). In some embodiments, the mapping policy can indicate the one or more UP values or the one or more TID values to which the L4S data flows may be mapped. In certain embodiments, the UP values or TID values can be mapped to the uplink L4S data flows, the downlink L4S data flows, or the P2P L4S data flows. In more embodiments, the mapping policy can be an enhanced Differentiated Services Code Point (DSCP) policy. In that, in some more embodiments, the enhanced DSCP policy may indicate mapping between the one or more DSCP values and the one or more corresponding UP values. In numerous embodiments, the enhanced DSCP policy can be a feature in the WFA QoS management. In many further embodiments, the process 500 can transmit an enhanced DSCP policy request to the wireless device. In still more embodiments, the enhanced DSCP policy request can be indicative of the mapping policy for the L4S data flow. In many additional embodiments, the process 500 may further receive an enhanced DSCP policy response from the wireless device. In still further embodiments, the enhanced DSCP policy response can be indicative of acceptance of the mapping policy for the L4S data flow by the wireless device.

In a number of embodiments, the process 500 can configure the mapping policy on the wireless device (block 520). In some embodiments, the process 500 may utilize a predetermined protocol or a proprietary protocol to configure the mapping policy on the wireless device. In certain embodiments, the wireless device may utilize the predetermined protocol or the proprietary protocol to map the L4S data flows. In more embodiments, the predetermined protocol or the proprietary protocol can facilitate mapping of the L4S data flows by the wireless device without requiring changes to standard DSCP policy.

In various embodiments, the process 500 may receive rTWT schedule from the wireless device (block 530). In some embodiments, the rTWT schedule can be indicative of the service interval and the service period for the L4S communication. In certain embodiments, process 500 may further receive the one or more rTWT TID values during the rTWT setup. In more embodiments, the process 500 can also receive the QoS IE indicative of the QoS characteristics of the L4S data flows from the wireless device during the rTWT setup. In some more embodiments, the process 500 may receive the SCS request from the wireless device indicative of the QoS characteristics of the L4S data flows.

In additional embodiments, the process 500 can receive the downlink L4S data flow associated with the wireless device (block 540). In some embodiments, the downlink L4S data flow may be associated with one or more real-time or near-real time applications executed on the wireless device. In certain embodiments, the process 500 can receive the downlink data flow and parse the one or more data packets in the downlink data flow to detect the congestion indicator or the L4S indicator. In more embodiments, upon detecting the congestion indicator or the L4S indicator, the process 500 may determine that the data flow is L4S.

In further embodiments, the process 500 may determine the rTWT TID value associated with the downlink L4S data flow based on the rTWT schedule (block 550). In some embodiments, the rTWT TID value can be utilized to identify the specific L4S data flow in the service period. In certain embodiments, different L4S data flows having different QoS characteristics may be mapped to different rTWT TID values. In more embodiments, the rTWT TID values can be utilized to carry over or continue the transmission or reception of the L4S data flows into the service period.

In many more embodiments, the process 500 can map the downlink L4S data flow to the rTWT TID value (block 560). In some embodiments, the downlink L4S data flow mapped to the rTWT TID value may be prioritized over the non-L4S data flow mapped to the same rTWT TID value. In certain embodiments, mapping the downlink L4S data flow to the rTWT TID value can be based on the mapping policy. In more embodiments, the process 500 may dynamically modify, change, or optimize the mapping policy.

In many additional embodiments, the process 500 may transmit the downlink L4S data flow to the wireless device during a service period (block 570). In some embodiments, the process 500 can implement a dual-queue AQM for scheduling the downlink L4S data flows and the non-L4S data flows. In certain embodiments, the process 500 may enqueue the L4S data flow in an L4S queue and the non-L4S data flow in a classic queue.

Although a specific embodiment for the process 500 for transmitting the L4S data flows by the AP for carrying out the various steps, processes, methods, and operations described herein is discussed with respect to FIG. 5, any of a variety of systems and/or processes may be utilized in accordance with embodiments of the disclosure. For example, the process 500 may dynamically classify and map the downlink L4S data flows. The elements depicted in FIG. 4 may also be interchangeable with other elements of FIGS. 1-4 and FIGS. 6-8 as required to realize a particularly desired embodiment.

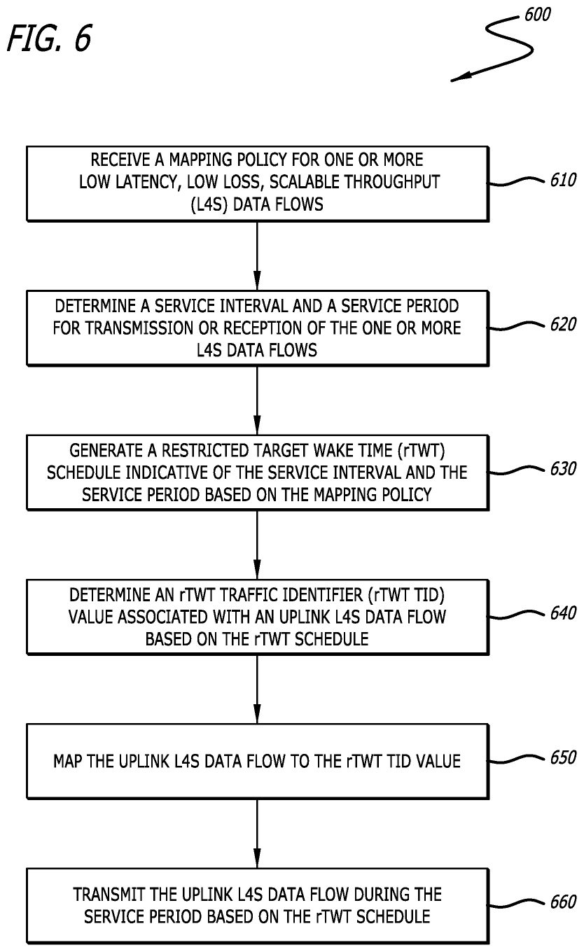

Referring now to FIG. 6, a flowchart depicting a process 600 for transmitting the L4S data flows by the wireless device, in accordance with various embodiments of the disclosure is shown. In many embodiments, the process 600 may receive the mapping policy for the L4S data flows (block 610). In some embodiments, the mapping policy can include the one or more UP values or the one or more TID values associated with the L4S data flows. In certain embodiments, the mapping policy can be configured on the wireless device.

In a number of embodiments, the process 600 can determine the service interval and the service period for transmission or reception of the one or more L4S data flows (block 620). In some embodiments, the service interval can indicate the time interval between transmission or reception of the L4S data flows from or to the process 600 implemented on the wireless device. In certain embodiments, for example, the service interval may indicate how often the wireless device transmits or receives the L4S data flows. In more embodiments, the service period can indicate the time period when the wireless device transmits or receives the L4S data flows.

In various embodiments, the process 600 may generate the rTWT schedule indicative of the service interval and the service period based on the mapping policy (block 630). In some embodiments, the rTWT schedule can be further indicative of, or transmitted with, the rTWT TID values associated with the L4S data flows in the service period. In certain embodiments, the rTWT setup may also include transmission of the QoS IE indicative of the one or more QoS characteristics of the L4S data flows.

In additional embodiments, the process 600 can determine the rTWT TID value associated with the uplink L4S data flow based on the rTWT schedule (block 640). In some embodiments, the rTWT TID value can be utilized to identify the specific L4S data flow in the service period. In certain embodiments, different L4S data flows having different QoS characteristics may be mapped to different rTWT TID values. In more embodiments, the rTWT TID values can be utilized to carry over or continue the transmission or reception of the L4S data flows into the service period.

In further embodiments, the process 600 may map the uplink L4S data flow to the rTWT TID value (block 650). In some embodiments, the process 600 can further map the uplink L4S data flow to the predetermined UP value, for example, a high UP value. In certain embodiments, the process 600 may map the uplink L4S data flow to the UP value or the TID value based on the mapping policy.

In many more embodiments, the process 600 can transmit the uplink L4S data flow during the service period based on the rTWT schedule (block 660). In some embodiments, the process 600 may prioritize the uplink L4S data flow over the non-L4S data flow. In certain embodiments, the process 600 can transmit the uplink data by utilizing an L4S queue.

Although a specific embodiment for the process 600 for transmitting the L4S data flows by the wireless device for carrying out the various steps, processes, methods, and operations described herein is discussed with respect to FIG. 6, any of a variety of systems and/or processes may be utilized in accordance with embodiments of the disclosure. For example, the process 600 may schedule wake up and sleep time based on the rTWT schedule to reduce power consumption. The elements depicted in FIG. 6 may also be interchangeable with other elements of FIGS. 1-5 and FIGS. 7-8 as required to realize a particularly desired embodiment.

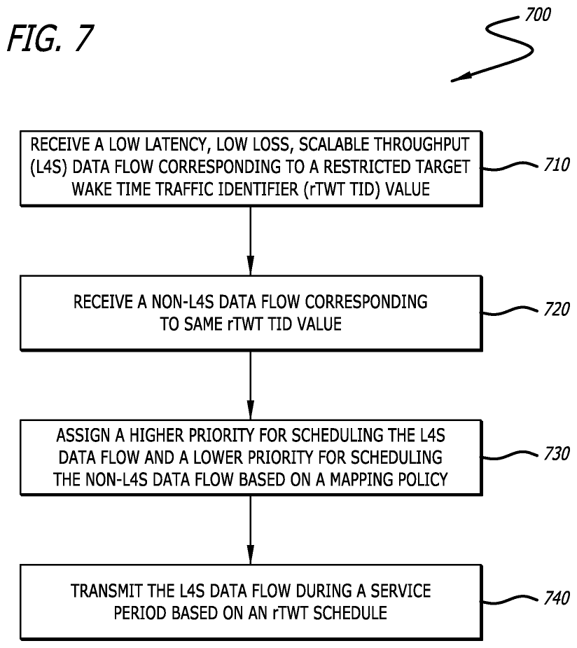

Referring now to FIG. 7, a flowchart depicting a process 700 for prioritizing the L4S data flows, in accordance with various embodiments of the disclosure is shown. In many embodiments, the process 700 can receive the L4S data flow corresponding to the rTWT TID value (block 710). In some embodiments, the rTWT TID value can be utilized to identify the specific L4S data flow in the service period. In certain embodiments, different L4S data flows having different QoS characteristics may be mapped to different rTWT TID values. In more embodiments, the rTWT TID values can be utilized to carry over or continue the transmission or reception of the L4S data flows into the service period.

In a number of embodiments, the process 700 can receive the non-L4S data flow mapped to same rTWT TID value (block 720). In some embodiments, the process 700 may determine that the data flow is the non-L4S data flow if the one or more data packets of the data flow do not comprise the ECN indicator or the L4S indicator. In certain embodiments, the non-L4S data flows can be the data flows that are not latency sensitive.

In various embodiments, the process 700 may assign a higher priority for scheduling the L4S data flow and a lower priority for scheduling the non-L4S data flow based on the mapping policy (block 730). In some embodiments, the process 700 can assign a higher UP value to L4S data flow and a lower UP value to non-L4S data flow. In some embodiments, the UP values can be assigned based on a predetermined DSCP to UP mapping policy. In certain embodiments, the process 700 may utilize the enhanced DSCP mapping policy. In certain embodiments, the process 700 can prioritize the L4S data flow by scheduling the L4S data first, by enqueuing the L4S data flow in the AQM queue or a shallow queue, or by utilizing a prioritized scheduler.

In additional embodiments, the process 700 can transmit the L4S data flow during the service period based on the rTWT schedule (block 740). In some embodiments, the process 700 can implement the dual AQM queue for scheduling the L4S data flow and the non-L4S data flow. In certain embodiments, the process 700 may enqueue the L4S data flow in the L4S queue and the non-L4S data flow in the classic queue.

Although a specific embodiment for the process 700 for prioritizing the L4S data flows for carrying out the various steps, processes, methods, and operations described herein is discussed with respect to FIG. 7, any of a variety of systems and/or processes may be utilized in accordance with embodiments of the disclosure. For example, the process 700 may classify, schedule, and prioritize the data flows based on the ECN indicator or the L4S indicator in the one or more data packets in the data flows. The elements depicted in FIG. 7 may also be interchangeable with other elements of FIGS. 1-6 and FIG. 8 as required to realize a particularly desired embodiment.

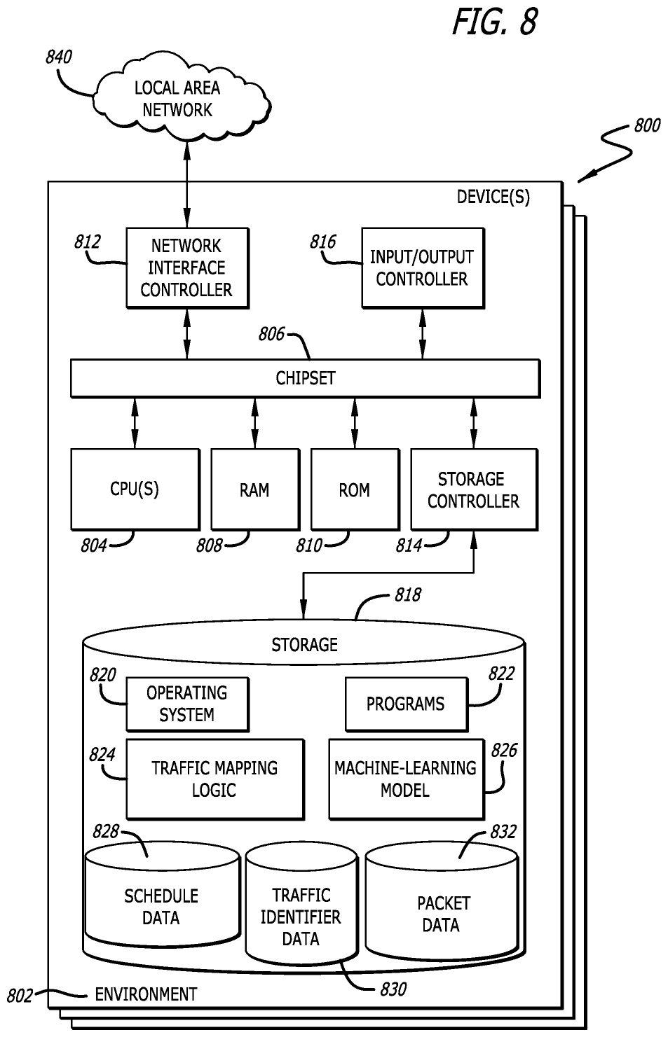

Referring to FIG. 8, a conceptual block diagram of a device 800 suitable for configuration with a traffic mapping logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, schedule data 828, traffic identifier data 830, and packet data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The schedule data 828 can store the rTWT schedule. In some embodiments, the schedule data 828 may store the service period and/or the service interval. The traffic identifier data 830 may store the one or more rTWT TID values. In certain embodiments, the traffic identifier data 830 can store the TID values mapped to the L4S data flows in the service period. The packet data 832 may store the L4S data packets. In more embodiments, the packet data 832 can store the uplink L4S data flows or the downlink L4S data flows.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a traffic mapping logic 824. The traffic mapping logic 824 can be configured to perform one or more of the various steps, processes, operations, and/or other methods that are described above. Often, the traffic mapping logic 824 can be a set of instructions stored within a non-volatile memory that, when executed by the processor(s)/controller(s) 804 can carry out these steps, etc. In some embodiments, the traffic mapping logic 824 may be a client application that resides on a network-connected device, such as, but not limited to, a server, switch, personal or mobile computing device in a single or distributed arrangement. The traffic mapping logic 824 can map the L4S data flows.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the schedule data 828, the traffic identifier data 830, and the packet data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the traffic mapping logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a traffic mapping logic, configured to:
determine a mapping policy for one or more Low Latency, Low Loss, Scalable throughput (L4S) data flows;
configure the mapping policy on a wireless device;
receive a restricted Target Wake Time (rTWT) schedule from the wireless device;
receive a downlink L4S data flow associated with the wireless device; and
schedule the downlink L4S data flow based on the rTWT schedule.

2. The device of claim 1, wherein the mapping policy is indicative of one or more User Priority (UP) values or one or more Traffic Identifier (TID) values associated with the one or more L4S data flows.

3. The device of claim 2, wherein the rTWT schedule is indicative of at least one service period occurring at one or more service intervals in which the wireless device transmits or receives the one or more L4S data flows.

4. The device of claim 3, wherein the rTWT schedule is further indicative of one or more rTWT TID values of the one or more TID values associated with the one or more L4S data flows.

5. The device of claim 4, wherein the rTWT schedule further includes a Quality of Service (QoS) Information Element (IE) indicative of one or more Quality of Service (QoS) parameters associated with the one or more L4S data flows.

6. The device of claim 5, wherein the traffic mapping logic is further configured to receive, from the wireless device, a Stream Classification Service (SCS) request indicative of the one or more QoS parameters associated with the one or more L4S data flows.

7. The device of claim 6, wherein scheduling the downlink L4S data flow comprises:
determining an rTWT TID value associated with the downlink L4S data flow based on the rTWT schedule; and
mapping the downlink L4S data flow to the rTWT TID value.

8. The device of claim 7, wherein scheduling the downlink L4S data flow further comprises:
determining the one or more QoS parameters associated with the downlink L4S data flow based on the SCS request or the QoS IE in the rTWT schedule; and
transmitting the downlink L4S data flow mapped to the rTWT TID value to the wireless device during the at least one service period based on the one or more QoS parameters.

9. The device of claim 8, wherein the traffic mapping logic is further configured to:
receive a non-L4S data flow mapped to the rTWT TID value; and
assign a higher priority for scheduling the downlink L4S data flow and a lower priority for scheduling the non-L4S data flow based on the mapping policy.

10. The device of claim 4, wherein the wireless device maps an uplink L4S data flow to an rTWT TID value associated with the uplink L4S data flow based on the rTWT schedule.

11. The device of claim 4, wherein the mapping policy is an enhanced Differentiated Services Code Point (DSCP) policy.

12. The device of claim 11, wherein the traffic mapping logic is further configured to:
transmit, to the wireless device, an enhanced DSCP policy request indicative of the mapping policy for the L4S data flow; and
receive, from the wireless device, an enhanced DSCP policy response indicative of acceptance of the mapping policy for the L4S data flow.

13. A device, comprising:
a processor;
a memory communicatively coupled to the processor; and
a traffic mapping logic, configured to:
receive a mapping policy for one or more Low Latency, Low Loss, Scalable throughput (L4S) data flows;
determine a service interval and a service period for transmission or reception of the one or more L4S data flows;
generate a restricted Target Wake Time (rTWT) schedule indicative of the service interval and the service period based on the mapping policy; and
transmit an uplink L4S data flow during the service period based on the rTWT schedule.

14. The device of claim 13, wherein the mapping policy is indicative of one or more User Priority (UP) values or one or more Traffic Identifier (TID) values associated with the one or more L4S data flows.

15. The device of claim 14, wherein the rTWT schedule is further indicative of one or more rTWT TID values of the one or more TID values associated with the one or more L4S data flows.

16. The device of claim 15, wherein transmitting the uplink L4S data flow comprises:
determining an rTWT TID value associated with the uplink L4S data flow based on the rTWT schedule; and
mapping the uplink L4S data flow to the rTWT TID value.

17. The device of claim 16, wherein transmitting the uplink L4S data flow comprises mapping the uplink L4S data flow to a predetermined rTWT TID value.

18. A method comprising:
determining a mapping policy for one or more Low Latency, Low Loss, Scalable throughput (L4S) data flows;
configuring the mapping policy on a wireless device;
receiving a restricted Target Wake Time (rTWT) schedule from the wireless device;
receiving a downlink L4S data flow associated with the wireless device; and
scheduling the downlink L4S data flow based on the rTWT schedule.

19. The method of claim 18, further comprising:
determining an rTWT Traffic Identifier (rTWT TID) value associated with the downlink L4S data flow based on the rTWT schedule;
mapping the downlink L4S data flow to the rTWT TID value;
determining a service period based on the rTWT schedule; and
transmitting the downlink L4S data flow to the wireless device during the service period.

20. The method of claim 19, further comprising:
receiving a non-L4S data flow corresponding to the rTWT TID value; and
assigning a higher UP value to the downlink L4S data flow and a lower UP value to the non-L4S data flow based on the mapping policy.
